(19) United States
(12) Patent Application Publication
(10) Pub. No.: US 2023/0309684 A1
(43) Pub. Date: Oct. 5, 2023

(54) Disposable Toothbrush with a Readily-Dispensable Amount of Toothpaste

(71) Applicant: Steven Echols, Lubbock, TX (US)

(72) Inventor: Steven Echols, Lubbock, TX (US)

(21) Appl. No.: 18/129,069

(22) Filed: Mar. 30, 2023

Related U.S. Application Data
(60) Provisional application No. 63/325,507, filed on Mar. 30, 2022.

(51) Int. Cl. A46B 11/00; A61C 15/04

(52) U.S. Cl. CPC A46B 11/0003; A61C 15/046; A46B 2200/1066

(57) ABSTRACT

A disposable toothbrush with a readily-dispensable amount of toothpaste is an apparatus that is single-use and self-pasting. The apparatus includes a toothbrush and at least one toothpaste dispenser. The toothbrush includes a brush handle, a paste channel, and a plurality of bristles. The paste channel traverses from one side of the brush handle to the other side of the brush handle. The toothpaste dispenser is in fluid communication with an inlet of the paste channel, while an outlet of the paste channel is positioned amongst the plurality of bristles so that a quantity of retained toothpaste can be readily dispensed for use amongst the plurality of bristles.

The current application claims a priority to the U.S. provisional patent application Ser. No. 63/325,507 filed on Mar. 30, 2022.

### FIELD OF THE INVENTION

The present invention generally relates to an oral hygiene device. More specifically, the present invention relates to a single-use toothbrush with a single-use amount of toothpaste.

### BACKGROUND OF THE INVENTION

A toothbrush is an oral hygiene tool used to clean the teeth, gums, and tongue. Toothbrushes typically consist of a head of tightly clustered bristles, upon which toothpaste is applied to, mounted on a handle which is used for cleaning the user's teeth. However, toothbrushes typically do not provide a readily-dispensable amount of toothpaste with them.

Therefore, an objective of the present invention is to provide an improved single-use toothbrush, which is an eco-friendly, biodegradable, and self-pasting for single use. This is very suitable for users on-the-go or away from home for easy oral hygiene. Additionally, the single-use applicability is good for avoiding the spread of germs and viruses that are commonly present on common toothbrushes today.

### BRIEF DESCRIPTION OF THE DRAWINGS

FIG. 1 is a top-front-left perspective view of the present invention.

FIG. 2 is a bottom-rear-right perspective view of the present invention.

FIG. 3 is a front view of the present invention.

FIG. 4 is a rear view of the present invention.

FIG. 5 is a side view of the present invention.

FIG. 6 is a cross-sectional view taken along line 6-6 in FIG. 3.

FIG. 7 is a side view of the present invention with a fingertip perch.

### DETAILED DESCRIPTION OF THE INVENTION

All illustrations of the drawings are for the purpose of describing selected versions of the present invention and are not intended to limit the scope of the present invention.

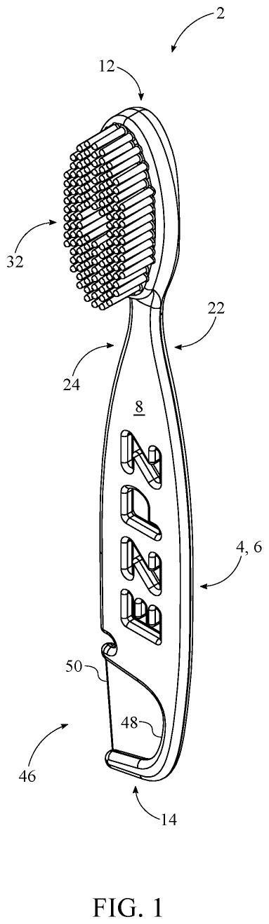

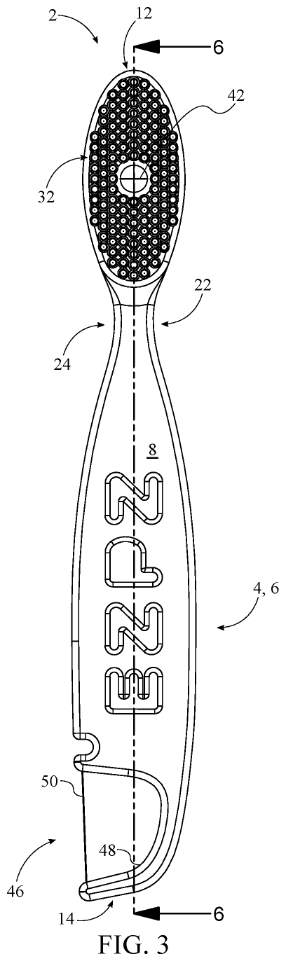

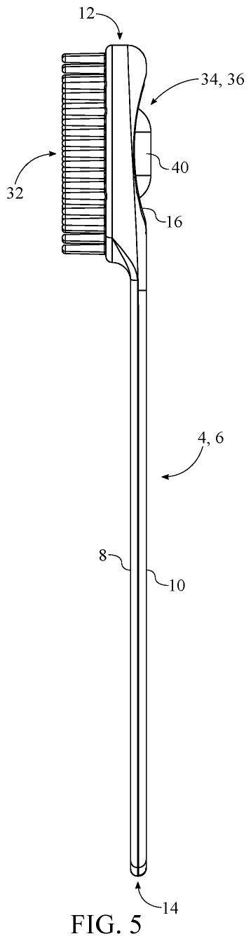

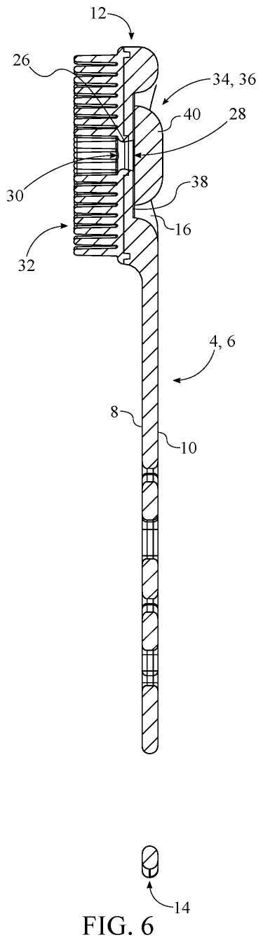

As can be seen in FIGS. 1 through 6, the present invention is a disposable toothbrush with a readily-dispensable amount of toothpaste. The present invention allows a user to brush their teeth at least one time by providing a single-use toothbrush, which can dispense a single-use amount of toothpaste. Thus, the present invention comprises a toothbrush 2 and at least one toothpaste dispenser 34. The toothbrush 2 has a minimalistic shape and configuration so that the toothbrush 2 is better suited as a single-use tool for brushing teeth. The at least one toothpaste dispenser 34 is a manually-actuated mechanism to dispense a set amount of toothpaste that is retained on the toothbrush 2.

Moreover, the toothbrush 2 comprises a brush handle 4, a paste channel 26, and a plurality of bristles 32, which are shown in FIGS. 1 through 6. The brush handle 4 is the main structural component of the toothbrush 2 that allows a user to grasp the toothbrush 2 as well as allows the plurality of bristles 32 to be held in place on the toothbrush 2. The paste channel 26 is used to delivery the set amount of toothpaste from the at least one toothpaste dispenser 34 and into the plurality of bristles 32. The plurality of bristles 32 with the set amount of toothpaste are then used to brush a user's teeth. Furthermore, the brush handle 4 comprises a flat elongated handle body 6, a proximal handle end 12, and a distal handle end 14. The flat elongated handle body 6 allows the toothbrush 2 to maintain its minimalistic shape and configuration. The proximal handle end 12 is the end of the brush handle 4 that is inserted into a user mouth, and the distal handle end 14 is the end of the brush handle 4 that is held outside the user's mouth. In addition, the paste channel 26 comprises a channel inlet 28 and a channel outlet 30. The channel inlet 28 is the end of the paste channel 26 that receives the set amount of toothpaste, and the channel outlet 30 is the end of the paste channel 26 that dispenses the set amount of toothpaste.

As can be seen in FIGS. 1 through 6, the general configuration of the aforementioned components allows the present invention to efficiently and effectively brush a user's teeth with a single-use product that can be mass produced in large quantities. In order to describe the arrangement of the other components on the brush handle 4, the flat elongated handle body 6 needs to comprise a first body face 8 and a second body face 10, which are typically flat parallel surfaces that are positioned opposite to each other about the flat elongated handle body 6. The plurality of bristles 32 is connected normal to the first body face 8, adjacent to the proximal handle end 12, so that the plurality of bristles 32 is properly positioned to be inserted into a user's mouth. The paste channel 26 traverses through the flat elongated body and out of the first body face 8, which allows the plurality of bristles 32 and the at least one toothpaste dispenser 34 to be positioned offset from each other and consequently prevents the plurality of bristles 32 and the at least one toothpaste dispenser 34 from operatively interfering with each other. The channel outlet 30 is positioned coincident to the first body face 8, adjacent to the proximal handle end 12, so that the channel outlet 30 can be positioned amongst the plurality of bristles 32 and can directly dispense the set amount of toothpaste into the plurality of bristles 32. In order to complete the path of toothpaste through the present invention, the at least one toothpaste dispenser 34 needs to be in fluid communication with the channel inlet 28.

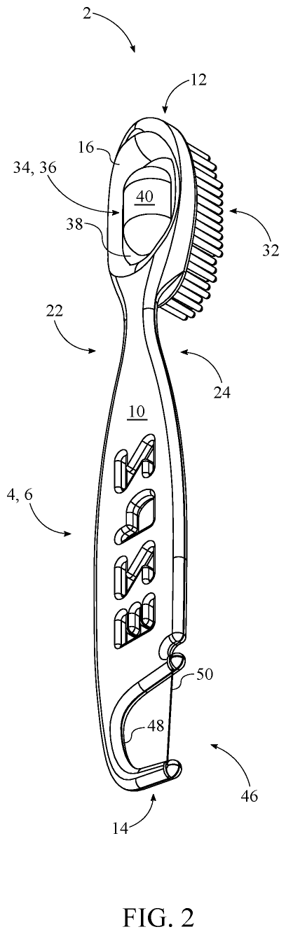

As can be seen in FIGS. 2 through 6, a preferred embodiment of the at least one toothpaste dispenser 34 comprises a burstable pod 36, which is manually actuated by squeezing the burstable pod 36 until the set amount of toothpaste pops out the burstable pod 36. The burstable pod 36 is mounted onto the second body face 10, adjacent to the proximal handle end 12, which prevents the burstable pod 36 from operatively interfering with the plurality of bristles 32 as the plurality of bristles 32 is brushing a user's teeth and allows the burstable pod 36 to be close enough to the plurality of bristles 32 to readily dispense the set amount of toothpaste into the plurality of bristles 32. The paste channel 26 consequently needs to traverse into the first body face 8, through the flat elongated handle body 6, and out of the second body face 10 in order for the set amount of toothpaste to travel from the burstable pod 36, through brush handle 4, and to the plurality of bristles 32. The channel inlet 28 also needs to be positioned coincident to the second body face 10, adjacent to the proximal handle end 12, so that the burstable pod 36 can be in fluid communication with the channel inlet 28.

In order to manually actuate the burstable pod 36, the burstable pod 36 may comprise a rigid pod portion 38, a collapsible pod portion 40, and a breakable feature 42, which are shown in FIGS. 2 through 6. The rigid pod portion 38 is the enclosure piece of the burstable pod 36 that cannot be deformed through a manually-applied force by a user, while the collapsible pod portion 40 is the enclosure piece of the burstable pod 36 that can be deformed by a manually-applied force by the user. The rigid pod portion 38 and the collapsible pod portion 40 are hermetically connected to each other so that the set amount of toothpaste cannot unintentionally leak out of the burstable pod 36. The rigid pod portion 38 is positioned against the second body face 10, and the collapsible pod portion 40 is positioned offset from the second body face 10, which allows a user to apply a manual force onto the collapsible pod portion 40 and thus compressing the burstable pod 36. The breakable feature 42 being integrated into the rigid pod portion 38 and is positioned adjacent to the channel inlet 28 so that the set amount of toothpaste exits the burstable pod 36 through the breakable feature 42 and enters the paste channel 26 as a user presses on the collapsible pod portion 40 and compresses the set amount of toothpaste inside the burstable pod 36. The breakable feature 42 is preferably a set of crisscrossing cuts in the rigid pod portion 38.

As can be seen in FIGS. 2 through 6, in order to securely situate the burstable pod 36, the brush handle 4 may further comprise a snap-locking recess 16, which allows a user to slowly push and snap the burstable pod 36 into place on the brush handle 4. The snap-locking recess 16 traverses from the second body face 10 into the flat elongated handle body 6, which provides the burstable pod 36 with some lateral support as the burstable pod 36 is situated within the snap-locking recess 16. The snap-locking recess 16 is positioned adjacent to the proximal handle end 12 in order to properly position the burstable pod 36 near the paste channel 26 and the plurality of bristles 32. The channel inlet 28 is positioned coincident to the snap-locking recess 16 because the channel inlet 28 needs to be near the breakable feature 42 as the set amount of toothpaste is released from the burstable pod 36 into the paste channel 26. The rigid pod portion 38 is releasably engaged into the snap-locking recess 16, which secures the burstable pod 36 in place on the brush handle 4 and allows the burstable pod 36 to potentially be replaced by a new burstable pod 36 with a new set amount of toothpaste. The snap-locking recess 16 may also use a beveled rim around its opening in order to receive and lock the rigid pod portion 38 in place within the snap-locking recess 16. The beveled rim is preferably slanted at 45 degrees in relation to a length of the flat elongated handle body 6.

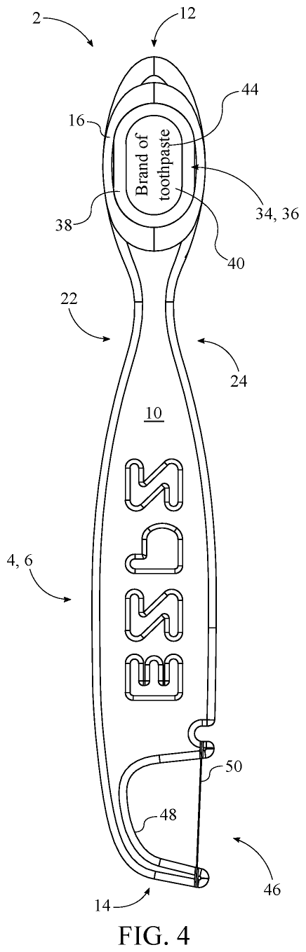

As can be seen in FIG. 4, in order to disseminate information with the burstable pod 36, the burstable pod 36 may comprise a graphic display 44, which can be, but is not limited to, a logo, a toothpaste brand name, a toothbrush brand name, an instruction, etc. The graphic display 44 is positioned adjacent to the collapsible pod portion 40, opposite to the rigid pod portion 38, and is inscribed into the collapsible pod portion 40, which allows the graphic display 44 to be easily seen by a user before pressing on the collapsible pod portion 40 to dispense the set amount of toothpaste.

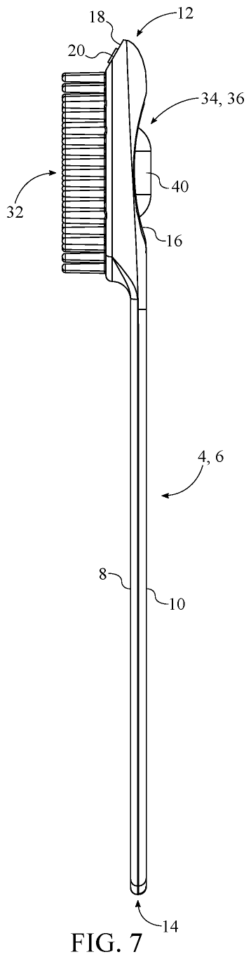

In order to better grip the brush handle 4 and the burstable pod 36 as a user presses on the collapsible pod portion 40, the brush handle 4 may need to further comprise a fingertip perch 18 and at least one grip feature 20, which are shown in FIG. 7. The fingertip perch 18 is a slanted feature of the brush handle 4 that is integrated in between the first body face 8 and the proximal handle end 12, which allows a user's thumb to press on the collapsible pod portion 40 in one direction as a user's finger presses on the fingertip perch 18 in an opposite direction. The fingertip perch 18 is preferably slanted at 60 degrees in relation to a length of the flat elongated handle body 6. The at least one grip feature 20 is a non-stick, friction-inducing piece of material that is connected across the fingertip perch 18 in order to improve a user's grip with their finger on the fingertip perch 18.

As can be seen in FIGS. 1 through 6, the present invention may further comprise a flosser 46, which allows a user to floss between two of their teeth. The flosser 46 is integrated into the distal handle end 14, which prevents the flosser 46 from interfering with a user brushing their teeth with the plurality of bristles 32 and prevents the plurality of bristles 32 from interfering with the user flossing their teeth with the flosser 46. Moreover, the flosser 46 may comprise a U-shaped floss bow 48 and a piece of floss 50. The U-shaped floss bow 48 is used to tie the piece of floss 50 between two points, which allows the piece of floss 50 to be tensioned between those two points. The U-shaped floss bow 48 is laterally integrated into the flat elongated handle body 6, and the piece of floss 50 being tensionably tethered across the U-shaped floss bow 48, which allows a user to easily grasp the brush handle 4 and then maneuver and slide the piece of floss 50 in between their teeth.

As can be seen in FIGS. 1 through 6, in order to more easily grasp the brush handle 4, the brush handle 4 may further comprise a first concave gripping edge 22 and a second concave gripping edge 24, which are opposing ergonomic features of the brush handle 4. The first concave gripping edge 22 and the second concave gripping edge 24 are positioned in between the proximal handle end 12 and the distal handle end 14 and are positioned along the flat elongated handle body 6. This arrangement for the first concave gripping edge 22 and the second concave gripping edge 24 allows a user's fingers and thumb to grasp the brush handle 4 just below the plurality of bristles 32 or allows the user's fingers and thumb to flip and grasp the brush handle 4 just below the flosser 46. Moreover, the first concave gripping edge 22 being laterally integrated into the flat elongated handle body 6, and the second concave gripping edge 24 is laterally integrated into the flat elongated handle body 6, opposite to the first concave gripping edge 22. This arrangement for the first concave gripping edge 22 and the second concave gripping edge 24 creates a reduced width portion for the brush handle 4 so that a user's fingers and thumb can more easily wrap around and grasp the brush handle 4.

### Supplemental Description

The present invention is a single-use, self-pasting, disposable toothbrush with an added flosser component. The present invention comprises a pod of toothpaste located on the backside of the toothbrush head. The pod would be pressed with the user's thumb, breaking open the pod and allowing the toothpaste to be pushed into the bristles from below through holes that are between the bristles going to toothpaste pod.

These toothbrushes are individually wrapped and sold in boxes. A 30-unit box could be offered, implying it's a one-month supply for the consumer, which means the user would be using one of the present invention per day.

The present invention is easily accessible and portable for use anywhere, such as work, school or wherever the user finds themselves away from home and needing a quick and easy way to brush their teeth.

Potential embodiments of present invention may be able to be made in one continued process with paste filling the pod on the toothbrush at same time, as opposed to having toothpaste pod manufactured separately and having to be connected to the toothbrush in a completely different process. This requires three main steps: first manufacturing the toothbrush; second manufacturing toothpaste pod, and third connecting both together.

The end of the brush would have a 45-degree angle on it allowing the user to put their finger for leverage while pressing paste through the holes. The back of the toothbrush would be concave allowing thumb to push all paste into the bristles. User can simply pull the toothbrush out of wrapper press paste into bristles, brush, rinse and throw the brush away.

An additional alternative and potential embodiment of the present invention is specifically targeted at the hotel industry. It offers a brush with at least 3 brushings of paste located in handle and pushed into bristles using a thumb to slide the paste up into bristles. This alternative embodiment would be offered to the hotel industry having enough paste for approximately 3 brushings; enough for an overnight stay at a hotel (which is the average stay of a hotel guest). Then, the toothbrush would be thrown away upon guest departure.

The present invention also offers licensing potential, in which toothpaste manufacturers could advertise their toothpaste on the toothbrush. Eventually, the present invention could have newer versions of itself offering dental flosser or a mouth full of mouthwash in handle for rinsing, cleaning, etc. Finally, a more biodegradable material than plastic could be utilized as well, which can be used to promote the eco-friendliness of the present invention.

Although the invention has been explained in relation to its preferred embodiment, it is to be understood that many other possible modifications and variations can be made without departing from the spirit and scope of the invention as hereinafter claimed.

What is claimed is:

1. A disposable toothbrush with a readily-dispensable amount of toothpaste comprising:
a toothbrush;
at least one toothpaste dispenser;
the toothbrush comprising a brush handle, a paste channel, and a plurality of bristles;
the brush handle comprising a flat elongated handle body, a proximal handle end, and a distal handle end;
the paste channel comprising a channel inlet and a channel outlet;
the flat elongated handle body comprising a first body face and a second body face;
the first body face and the second body face being positioned opposite to each other about the flat elongated handle body;
the first body face and the second body face being positioned parallel to each other;
the plurality of bristles being connected normal to the first body face, adjacent to the proximal handle end;
the paste channel traversing through the flat elongated handle body and out of the first body face;
the channel outlet being positioned coincident to the first body face, adjacent to the proximal handle end;
the channel outlet being positioned amongst the plurality of bristles; and
the at least one toothpaste dispenser being in fluid communication with the channel inlet.

2. The disposable toothbrush with a readily-dispensable amount of toothpaste as claimed in claim 1 comprising:
the at least one toothpaste dispenser comprising a burstable pod;
the burstable pod being mounted onto the second body face, adjacent to the proximal handle end;
the paste channel traversing into the first body face, through the flat elongated handle body, and out of the second body face;
the channel inlet being positioned coincident to the second body face, adjacent to the proximal handle end; and
the burstable pod being in fluid communication with the channel inlet.

3. The disposable toothbrush with a readily-dispensable amount of toothpaste as claimed in claim 2 comprising:
the burstable pod comprising a rigid pod portion, a collapsible pod portion, and a breakable feature;
the rigid pod portion and the collapsible pod portion being hermetically connected to each other;
the rigid pod portion being positioned against the second body face;
the collapsible pod portion being positioned offset from the second body face;
the breakable feature being integrated into the rigid pod portion; and
the breakable feature being positioned adjacent to the channel inlet.

4. The disposable toothbrush with a readily-dispensable amount of toothpaste as claimed in claim 3 comprising:
the brush handle further comprising a snap-locking recess;
the snap-locking recess traversing from the second body face into the flat elongated handle body;
the snap-locking recess being positioned adjacent to the proximal handle end;
the channel inlet being positioned coincident to the snap-locking recess; and
the rigid portion being releasably engaged into the snap-locking recess.

5. The disposable toothbrush with a readily-dispensable amount of toothpaste as claimed in claim 3 comprising:
the burstable pod further comprising a graphic display;
the graphic display being positioned adjacent to the collapsible pod portion, opposite to the rigid pod portion; and
the graphic display being inscribed into the collapsible pod portion.

6. The disposable toothbrush with a readily-dispensable amount of toothpaste as claimed in claim 2 comprising:
the brush handle further comprising a fingertip perch and at least one grip feature;
the fingertip perch being integrated in between the first body face and the proximal handle end; and
the at least one grip feature being connected across the fingertip perch.

7. The disposable toothbrush with a readily-dispensable amount of toothpaste as claimed in claim 1 comprising:
a flosser; and
the flosser being integrated into the distal handle end.

8. The disposable toothbrush with a readily-dispensable amount of toothpaste as claimed in claim 7 comprising:
the flosser comprising a U-shaped floss bow and a piece of floss;
the U-shaped floss bow being laterally integrated into the flat elongated handle body; and
the piece of floss being tensionably tethered across the U-shaped floss bow.

9. The disposable toothbrush with a readily-dispensable amount of toothpaste as claimed in claim 1 comprising:
the brush handle further comprising a first concave gripping edge and a second concave gripping edge;
the first concave gripping edge and the second concave gripping edge being positioned in between the proximal handle end and the distal handle end;
the first concave gripping edge and the second concave gripping edge being positioned along the flat elongated handle body;
the first concave gripping edge being laterally integrated into the flat elongated handle body; and
the second concave gripping edge being laterally integrated into the flat elongated handle body, opposite to the first concave gripping edge.

10. A disposable toothbrush with a readily-dispensable amount of toothpaste comprising:
a toothbrush;
at least one toothpaste dispenser;
the toothbrush comprising a brush handle, a paste channel, and a plurality of bristles;
the at least one toothpaste dispenser comprising a burstable pod;
the brush handle comprising a flat elongated handle body, a proximal handle end, and a distal handle end;
the paste channel comprising a channel inlet and a channel outlet;
the flat elongated handle body comprising a first body face and a second body face;
the first body face and the second body face being positioned opposite to each other about the flat elongated handle body;
the first body face and the second body face being positioned parallel to each other;
the plurality of bristles being connected normal to the first body face, adjacent to the proximal handle end;
the paste channel traversing through the flat elongated handle body and out of the first body face;
the channel outlet being positioned coincident to the first body face, adjacent to the proximal handle end;
the channel outlet being positioned amongst the plurality of bristles;
the at least one toothpaste dispenser being in fluid communication with the channel inlet;
the burstable pod being mounted onto the second body face, adjacent to the proximal handle end;
the paste channel traversing into the first body face, through the flat elongated handle body, and out of the second body face;
the channel inlet being positioned coincident to the second body face, adjacent to the proximal handle end; and
the burstable pod being in fluid communication with the channel inlet.

11. The disposable toothbrush with a readily-dispensable amount of toothpaste as claimed in claim 10 comprising:
the burstable pod comprising a rigid pod portion, a collapsible pod portion, and a breakable feature;
the rigid pod portion and the collapsible pod portion being hermetically connected to each other;
the rigid pod portion being positioned against the second body face;
the collapsible pod portion being positioned offset from the second body face;
the breakable feature being integrated into the rigid pod portion;
the breakable feature being positioned adjacent to the channel inlet;

12. The disposable toothbrush with a readily-dispensable amount of toothpaste as claimed in claim 11 comprising:
the brush handle further comprising a snap-locking recess;
the snap-locking recess traversing from the second body face into the flat elongated handle body;
the snap-locking recess being positioned adjacent to the proximal handle end;
the channel inlet being positioned coincident to the snap-locking recess; and
the rigid portion being releasably engaged into the snap-locking recess.

13. The disposable toothbrush with a readily-dispensable amount of toothpaste as claimed in claim 11 comprising:
the burstable pod further comprising a graphic display;
the graphic display being positioned adjacent to the collapsible pod portion, opposite to the rigid pod portion; and
the graphic display being inscribed into the collapsible pod portion.

14. The disposable toothbrush with a readily-dispensable amount of toothpaste as claimed in claim 10 comprising:
the brush handle further comprising a fingertip perch and at least one grip feature;
the fingertip perch being integrated in between the first body face and the proximal handle end; and
the at least one grip feature being connected across the fingertip perch.

15. The disposable toothbrush with a readily-dispensable amount of toothpaste as claimed in claim 10 comprising:
a flosser; and
the flosser being integrated into the distal handle end.

16. The disposable toothbrush with a readily-dispensable amount of toothpaste as claimed in claim 15 comprising:
the flosser comprising a U-shaped floss bow and a piece of floss;
the U-shaped floss bow being laterally integrated into the flat elongated handle body; and
the piece of floss being tensionably tethered across the U-shaped floss bow.

17. The disposable toothbrush with a readily-dispensable amount of toothpaste as claimed in claim 10 comprising:
the brush handle further comprising a first concave gripping edge and a second concave gripping edge;
the first concave gripping edge and the second concave gripping edge being positioned in between the proximal handle end and the distal handle end;
the first concave gripping edge and the second concave gripping edge being positioned along the flat elongated handle body;
the first concave gripping edge being laterally integrated into the flat elongated handle body; and
the second concave gripping edge being laterally integrated into the flat elongated handle body, opposite to the first concave gripping edge.
